(19) United States
(12) Patent Application Publication
(10) Pub. No.: US 2001/0033566 A1
(43) Pub. Date: Oct. 25, 2001

(54) Methods and apparatus for providing telephonic communication services

(76) Inventor: David W. Grimes, Crownsville, MD (US)

Correspondence Address: Raymond N. Baker, Shanley and Baker, 2233 Wisconsin Ave. N.W., Washington, DC, 20007, US

(21) Appl. No.: 09/781,346

(22) Filed: Feb. 12, 2001

Related U.S. Application Data
(60) Provisional application No. 60/181,519, filed on Feb. 10, 2000.

(51) Int. Cl. H04L 12/66; H04J 3/00

(52) U.S. Cl. 370/352; 370/476

(57) ABSTRACT

Methods and equipment for establishing a voice and data telecommunications system with the benefits of hardwiring, free of a requirement for extending telephone copper wire service to geographical areas, or into building complexes, where none exits. An electrical capacitive interconnection is established which enables use of existing analog-operated carrier mediums to provide the benefits of hardwired telephone service. Outgoing messages in analog are converted to digital for telephone communication. In a specific embodiment, a capacitive interconnection enables compatible utilization of electrical power lines for carrying such digital signal telecommunication, which is then converted to analog at a receiving location. Computer-operated control enables voice/data communication between multiple users in which communications can be sent and received simultaneously, in both directions, over the same line.

This application claims the priority of U.S. Provisional Patent Application Ser. No. 60/181,519.

### INTRODUCTION

This invention is concerned with methods and apparatus for providing unique telephonic communication services using established public utility lines as a carrier medium. A new combination of steps, software and equipment enables linking voice/data telephone communications between multiple users without copper wiring, utilizing a carrier medium, including electrical power service.

### OBJECTS OF THE INVENTION

A specific objective is to enable use of electrical utility power lines as a telephonic communications carrier network.

A further object is to utilize established electrical utility power lines, so as to eliminate a need for extending expensive telephone copper wire, fiber optics, or other physical carrier lines for telephonic communications to each residence or each telephone user in a building complex which is free of telephone wiring.

A further object is to provide interfacing of a telephonic communication network with electrical power lines, in a manner which converts established high voltage power lines to voice and data communication service.

A specific object is to enable direct telephonic communications between multiple users relying on existing public utility power lines to such users.

A further object is to provide electronic control, enabling simultaneous telephonic communication free of telephonic hardwiring, between multiple users, providing for such communication in both directions utilizing the same carrier line.

The above and other objects, features and advantages are described in more detail with references to the accompanying drawings.

### BRIEF DESCRIPTION OF THE DRAWINGS

FIG. 1 is a general arrangement schematic presentation of equipment in the form of a block diagram for describing an individual service embodiment of the invention;

FIG. 2 is a general arrangement schematic presentation in the form of a block diagram for describing gateway switching apparatus of the invention for voice/data packet communications between multiple users.

### DETAILED DESCRIPTION

Solid-state developments and electronic capabilities have concentrated on, and expanded (a) the use of computer Internet services, (b) expensively installed cable television services and fiber-optic carriers in populous metropolitan areas, and (c) the use of wireless phones which continue to be of limited range and limited dependability. However, remote and developing areas have been denied the benefits of hardwired telephonic services because of the cost of extending copper wire telephone lines to those areas, or to building complexes which are without hardwired telephone lines.

Inadequate conditions for those remote areas, and building and industrial complexes without hardwired telephone services, have existed for decades with no conception of the contributions of, or the problems solved by present teachings. New combinations, as taught herein, of developing solid-state electronic capabilities make hardwired-system telephonic benefits available to remote and developing areas; and provide special benefits to business, industrial and apartment complexes which are served, for example, by existing utility power lines, free of any necessity for utilizing hardwired telephone lines.

Compatibility of telephone communications, and of existing public telephone services is achieved through predetermined capacitive interconnecting means of the invention.

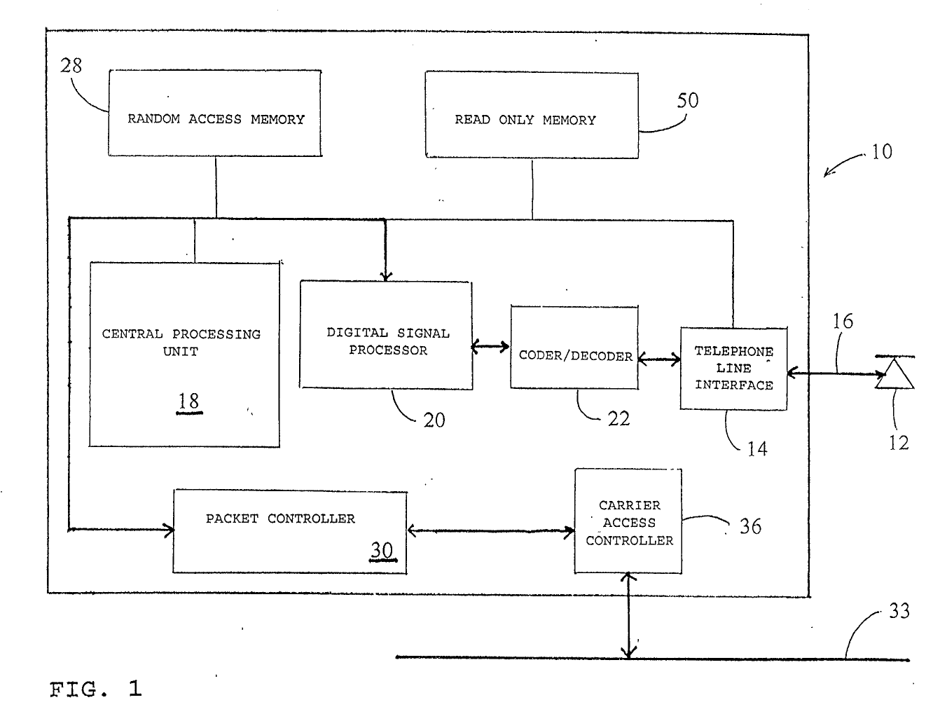

In the specific embodiment of FIG. 1, indicated generally at 10, a residential service unit telephone 12 is connected by telephonic subscriber interface 14 with line 16, which provides for communication in both incoming and outgoing directions.

In practice of the invention, central processing unit (CPU) 18 constantly monitors interface means 14 to detect any indication of intended use of telephone 12, such as lifting a receiver for an outgoing call, or an indication of an incoming call.

If a call is to be made, the following sequence takes place electronically when a “calling” condition is detected, when the phone handset is lifted from telephone 12: CPU 18 activates digital signal processor means 20 to generate a digital dial tone signal; such digital signal is converted to an analog dial tone by coder/decoder unit 22, and that analog dial tone is directed, by telephone line interface 14, over dual-direction means for utilization by telephone 12.

As a first number button on telephone 12 is pressed, an analog dial tone multi-frequency signal is sent by telephone 12 to digital signal processor 20, by means of coder/decoder 22, which converts such analog tone signal to pulse code modulation (PCM) format for digital signal processor 20. Such PCM format pulse tone signal is processed by digital signal processor 20 which identifies the number first pressed on telephone 12. Such number is directed to CPU 18 which stores such number in random access memory (RAM) 28. CPU 18 utilizes digital signal processor 20 to remove such dial tone signal from telephone 12. Subsequent numbers, corresponding to additional button number selections on telephone 12, are similarly collected by CPU 18 and stored in RAM 28 in the same prompt handling sequence expected in copper wired telephony.

When sufficient numbers to form an address have been collected by CPU 18, supervisory information is appended to such address to form a data packet in protocol for transmission control.

Such data packet comprises a plurality of binary digits, in which data and control signals are delivered by CPU 18 as a composite whole. Such data packet includes data, call control signals, and possible error-control information arranged in a specified sequence and format for functioning. Packet controller 30 directs such data packet, for transfer from the service unit 10 to carrier 33 (such as an electrical power utility line), via carrier access controller 36.

In accordance with a specific embodiment of the invention, an electrical capacitive interconnection with carrier 33 is provided by carrier access controller 36, which enables transfer of digital-signal telephonic communications to an established physical carrier, such as a public utility line transmitting high voltage electrical power in analog form; for example, at 60 Hertz. The electrical capacitive connection enables safe access for carrying digital data packets on electrical power utility carrier line 33.

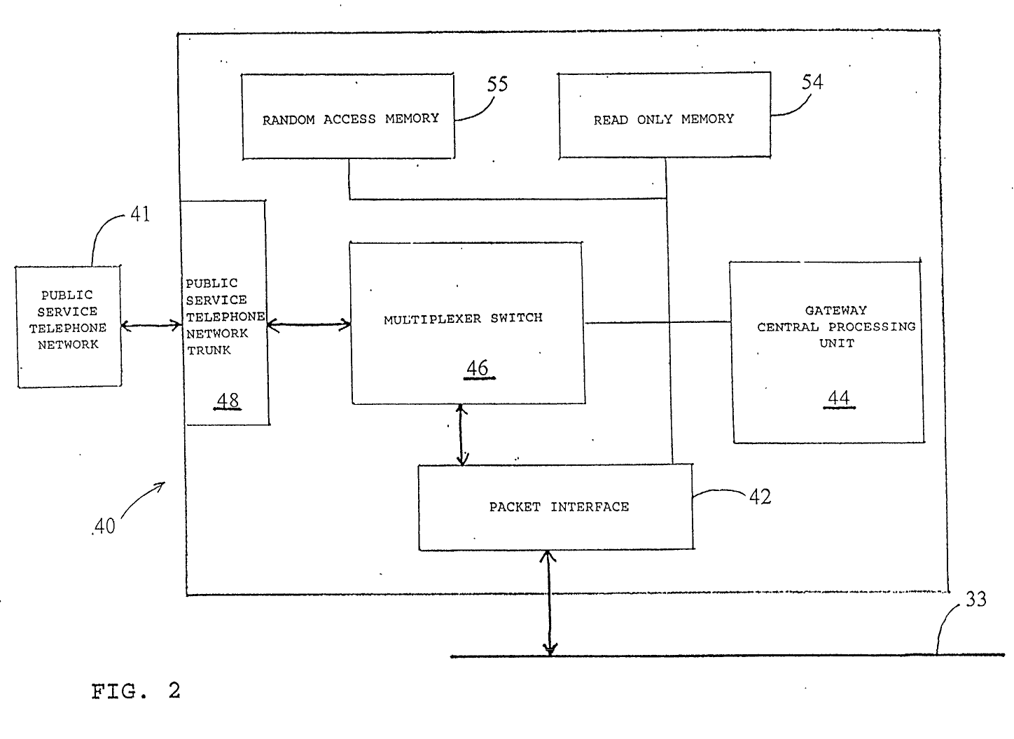

Referring to FIG. 2, gateway switch means, indicated generally at 40, includes electronic equipment making provisions for an interface power line for carrier 33, for digital packets from an individual service unit 10 (FIG. 1), with a public service telephone network 41 (FIG. 2) which is connected for dual-direction communication with the electronic components of gateway means 40. The contribution of components of gateway means 40 enables an established public service telephone network to be connected into, and operate over, a power utility carrier network (such as 33), so as to make telephone 12 of FIG. 1, which is not copper-wired for telephone service, accessible to established public service telephone networks.

Packet interface 42 (FIG. 2) provides coupling for gateway means 40 to carrier 33. Digital data packets are directed from packet interface 42 by gateway CPU 44, which also controls multiplexer switch 46.

A digital data packet is converted to analog by packet interface 42. CPU 44 provides control of switch 46, which directs the analog signal to trunk 48 for access to the public service telephone network 41 and delivery to a receiving address.

Once an initial connection has been established between telephone 12 and another telephone, voice and data can be transferred in a similar fashion. An analog voice signal is passed from telephone 12 to signal processor 20. A voice coder in signal processor 20 converts such analog voice signal to digital data packets consisting of digital audio data which are passed to packet controller 30 to be sent along carrier 33 to gateway switch means 40. A voiceover chip of the type used for providing Internet voice communications is used within packet controller 30 to enable audio transmission initially over a selected carrier medium, such as electrical power lines, public service telephone lines, and other carrier media by proper selection of interfacing.

Multiplexer switch 46 and packet interface 42 control distribution of incoming and outgoing data packets. Time division multiplexer switch 46 enables a plurality of data packet signals to be transmitted to multiple users over a single carrier.

For a communication connection which does not require access to a public service telephone network (such as within an industrial complex), gateway switch means 40 routes such data packet signals to an appropriate address, by means of multiplexer switch 46, for incoming and outgoing data traffic, which can be handled simultaneously over carrier 33, directly through packet interface 42.

Operating instructions for service unit 10 are contained in read only memory 50 (FIG. 1). Operating instructions for gateway switch means 40 are contained in read only memory 54 (FIG. 2). Gateway CPU 44 is provided with random access memory 55.

While specific components and steps have been set forth for purposes of describing embodiments of the invention, various modifications can be made in the light of the above teachings without departing from applicants patentable contributions; therefore in determining the scope of patent protection for the present invention, reference shall be made to the claims.

1. Method for providing telephonic communication services, comprising the steps of:
(A) obtaining an analog signal from a telephone for selection from the group consisting of:
(i) initiating a message, and
(ii) receiving a message;
(B) converting such analog signal to digital;
(C) creating a plurality of outgoing digital data packets from individual digital signals, and
(D) providing an interface for transfer of such digital data packets to an analog-operated carrier medium, having hardwired characteristics, selected from the group consisting of:
(i) 110 volt, 3-phase electric utility power lines,
(ii) 220 volt, 3-phase electric utility power lines,
(iii) fiber optic lines,
(iv) coaxial cable, and combinations thereof,
while providing for selection from the group consisting of initiating a message, receiving a message, and combinations thereof.

2. The method of claim 1, including the step of selecting an electrical capacitive interface for transfer of such digital data packets to an analog-operated electrical power transmission network carrier medium.

3. The method of claim 1, in which
such digital signal packet transfers are selected from the group consisting of:
(i) voice,
(ii) data, and
(iii) combinations of (i) and (ii).

4. The method of claim 1, further comprising:
(A) receiving a plurality of incoming digital data packets as individual digital signals;
(B) converting such digital signals to analog; and
(C) sending such converted analog signals over such analog-operated carrier medium, with selection from the group consisting of to a single telephone user, and to multiple telephone users.

5. Apparatus for providing telephonic communication service over a carrier medium having hardwired characteristics, free of a requirement for installing a telephonic hardwired transmission line, by combining:
(A) a user service unit, including
(i) interface means for connecting such service unit to a telephone,
(ii) digital signal processor means,
(iii) coder/decoder means,
(iv) control processor means for such service unit for controlling operation of such digital signal processor means, including:
(a) read only memory with operating instructions from such central processing unit, and
(b) random access memory;
(v) packet controller means, and
(vi) carrier access controller means;
(B) a gateway means, comprising
(i) packet interface means, including means for connecting to such carrier medium,
(ii) multiplexer means, and
(iii) gateway central processor means for controlling operation of such multiplexer means, including
(a) read only memory with operating instructions from such gateway central processor means, and
(b) random access memory; and
(C) connector means for connecting such gateway means to a public service telephone network trunk.

6. The apparatus of claim 5, wherein
such digital signal processor means of such service unit includes a voice coder.

7. The apparatus of claim 6, wherein
such packet controller of such service unit utilizes a voice-over telephone chip.

8. The apparatus of claim 7, wherein such carrier medium is selected from the group consisting of:
(i) 110 volt, 3-phase electric utility power lines,
(ii) 220 volt, 3-phase electric utility power lines,
(iii) fiber optic lines,
(iv) coaxial cable, and combinations thereof.
